(19) United States
(12) Patent Application Publication
(10) Pub. No.: US 2008/0159837 A1
(43) Pub. Date: Jul. 3, 2008

(54) Freight loading system of trailer

(75) Inventor: Byeong Kil Jeon, Ulsan (KR)

Correspondence Address: RABIN & Berdo, PC, 1101 14TH STREET, NW, SUITE 500, WASHINGTON, DC, 20005, US

(73) Assignees: MTLOGISTICS CO., LTD., Nam-gu (KR); GIL ENGINEERING CO., LTD., Ulsan (KR)

(21) Appl. No.: 11/647,321

(22) Filed: Dec. 29, 2006

(51) Int. Cl. B60P 1/00; B60P 1/16

(52) U.S. Cl. 414/495; 414/708

(57) ABSTRACT

Provided is a freight loading system of a trailer including: a loading container having a loading section in which freight is loaded; a conveyor installed at the loading section, and conveying the freight into the loading container using a drive motor; a palette on which the freight is loaded to be conveyed by the conveyor; a palette up/down cylinder installed at the loading section; a palette lifting member for lifting the loading palette over the conveyor using the palette up/down cylinder; a palette fixing part for fixing the loading palette lifted over the conveyor by the palette lifting member; a freight fixing cylinder for pressing and fixing the freight loaded on the loading palette; and a pressure supply apparatus for supplying hydraulic or pneumatic pressure to operate the palette up/down cylinder and the freight fixing cylinder.

### BACKGROUND OF THE INVENTION

1. Field of the Invention

The present invention relates to a trailer and, more particularly, to a freight loading system of a trailer capable of readily loading and unloading freight in a state that the trailer is connected to a vehicle.

2. Description of Related Art

Generally, freight is loaded on and transported by a large vehicle or a truck. In order to prevent the freight from falling out and facilitate its transportation, a trailer is connected to the vehicle, and the freight is loaded on the trailer.

When the freight is loaded on the trailer connected to the vehicle, the freight is loaded by a worker or using equipment such as a forklift. In addition, in order to load a large amount of freight, the freight should be moved and arranged from a rear part to a front part of the trailer.

While lightweight and compact freight can be readily loaded and arranged by workers, loading and arrangement of heavyweight and bulky freight require many workers and time-consuming operations, and a safety accident may occur.

Therefore, recently, a conveyor is installed at an inner bottom of the trailer connected to the vehicle, and the freight is loaded and arranged by controlling the conveyor.

Trailers employing such a conveyor are disclosed in Korean Utility Model Publication No. 1992-11771, Korean Utility Model Laid-open Publication No. 1991-14175, Korean Utility Model Laid-open Publication No. 1997-61548, Japanese Patent Laid-open Publication No. H08-108788, Japanese Utility Model Laid-open Publication No. H07-18972, and so on.

However, since freight conveyed by the conveyor and loaded on the trailer is transported by a vehicle in a state that the freight is unfixed to the trailer, the freight may be moved from its initial loading position to be damaged.

### SUMMARY OF THE INVENTION

The present invention has been contrived taking the above-described circumstances into consideration, and an object of the present invention is to provide a freight loading system of a trailer capable of stably and readily loading freight, and securely fixing the loaded freight to prevent damage of the freight due to shaking during transport.

Other objects and advantages of the present invention will be described hereinafter and become more apparent from preferred embodiments of the present invention.

Moreover, the objects and advantages of the present invention can be embodied by means and combinations set forth in the appended claims.

In order to accomplish the above object, there is provided a freight loading system of a trailer including: a loading container having a loading section, a door installed at the rear thereof, and a plurality of wheels installed thereunder; a conveyor installed in a longitudinal direction of the loading section; a drive motor for driving the conveyor; a plurality of loading palettes conveyed into the loading container by the conveyor in a state that freight is loaded; a plurality of palette up/down cylinders installed at the bottom of the loading section; a plurality of palette lifting members connected to the palette up/down cylinders, installed in a longitudinal direction at the bottom of the loading section, and lifting the loading palettes over the conveyor using the palette up/down cylinders such that the loading palettes are not conveyed when the first conveyed loading palette is completely introduced into the foremost of the loading conveyor by the conveyor; a plurality of palette fixing parts installed at the loading container and the palette lifting members, and fixing the loading palettes lifted upward by the palette lifting members; a plurality of freight fixing cylinders longitudinally installed at an upper surface of the loading section at predetermined intervals, and pressing and fixing the freight loaded on the loading palettes when the lifted loading palettes are fixed by the palette lifting members and the palette fixing parts; and a pressure supply apparatus installed at the loading container and supplying hydraulic or pneumatic pressure to operate the palette up/down cylinders and the freight fixing cylinders.

### BRIEF DESCRIPTION OF THE DRAWINGS

FIG. 1 is a side cross-sectional view of a freight loading system of a trailer in accordance with an exemplary embodiment of the present invention;

FIG. 2 is a plan cross-sectional view of FIG. 1;

FIG. 3 is a rear cross-sectional view of FIG. 1;

FIG. 4 is a perspective view of a loading palette shown in FIG. 1;

FIG. 5 is an enlarged perspective view of a palette lifting member shown in FIG. 1;

FIG. 6A is an enlarged cross-sectional view of portion A of FIG. 3; and

FIG. 6B is an enlarged cross-sectional view of portion B of FIG. 3.

### DETAILED DESCRIPTION OF THE INVENTION

Hereinafter, preferred embodiments of the present invention will now be described with reference to the accompanying drawings. First of all, terms and words used in the specification and the claims should be interpreted not in a limited normal or dictionary meaning, but to include meanings and concepts conforming with technical aspects of the present invention, based on the fact that the inventor may appropriately define a concept of a term to describe his/her own invention in a best way.

Therefore, the configurations described in the specification and drawn in the figures are just most preferred embodiments of the present invention, not to show all of the technical aspects of the present invention. So, it should be understood that there might be various equalities and modifications to be replaced with them at this point of time when the present application is filed.

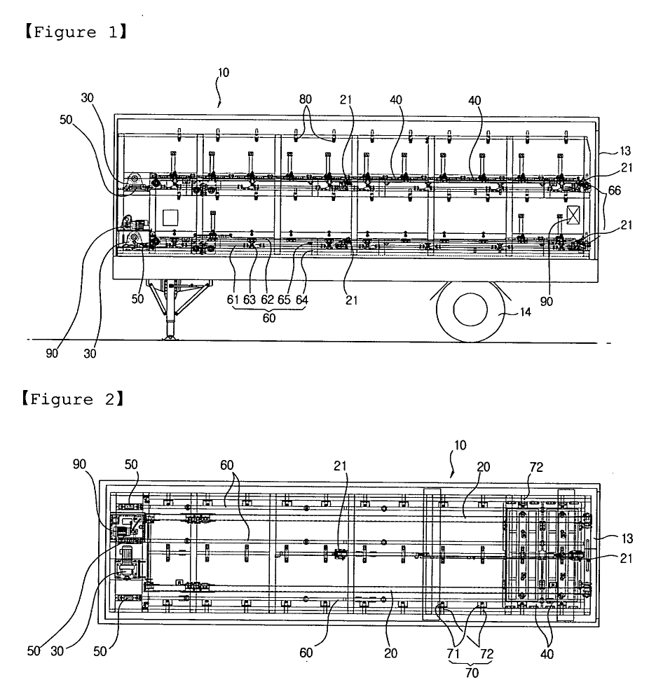

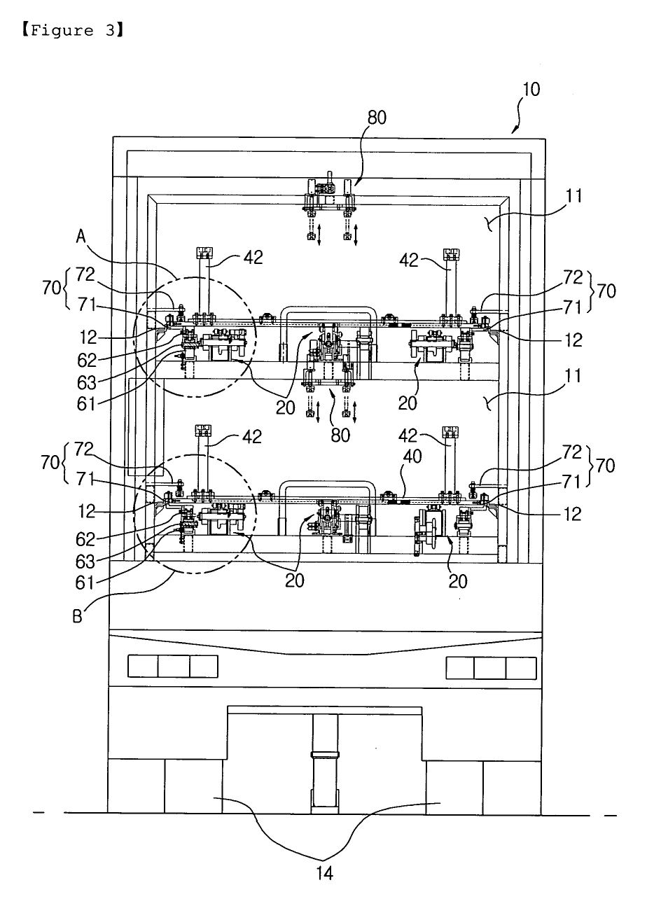

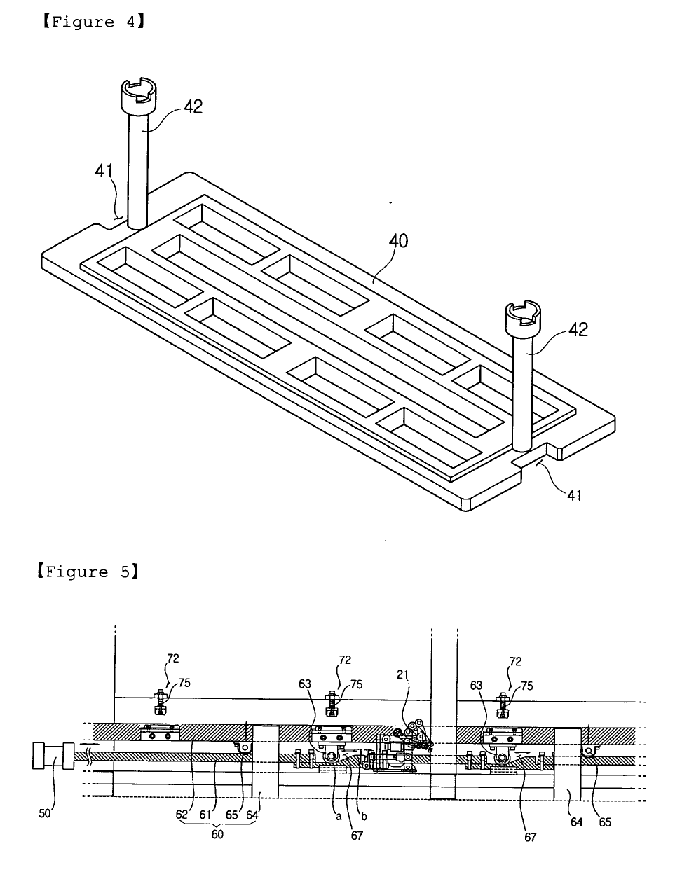

FIG. 1 is a side cross-sectional view of a freight loading system of a trailer in accordance with an exemplary embodiment of the present invention, FIG. 2 is a plan cross-sectional view of FIG. 1, and FIG. 3 is a rear cross-sectional view of FIG. 1.

As shown in FIGS. 1 to 3, a freight loading system of a trailer in accordance with an exemplary embodiment of the present invention includes a loading container 10 connected to a vehicle and having a plurality of loading sections 11 for loading freight in a multi-stage manner, and conveyors 20 installed at the bottoms of the loading sections 11 and conveying freight into the loading container 10 using a drive motor 30.

In addition, the freight loading system of a trailer further includes loading palettes 40, on which the freight is loaded, to be conveyed by the conveyors 20, palette up/down cylinders 50 installed at each loading section 11 of the loading container 10, and palette lifting members 60 for lifting the loading palettes 40 over the conveyors 20 when the palette up/down cylinders 50 operate.

Further, the freight loading system of a trailer further includes palette fixing parts 70 for preventing vertical and horizontal movement of the loading palettes 40 lifted over the conveyors 20, and freight fixing cylinders 80 for pressing and fixing the freight on the lifted loading palettes 40.

Also, the freight loading system of a trailer further includes a pressure supply apparatus 90 installed at the loading container 10 and supplying hydraulic or pneumatic pressure into the palette up/down cylinders 50 and the freight fixing cylinders 80 to operate them.

The loading container 10, in which freight can be loaded, is connected to a vehicle, and has a multi-stage of loading sections 11 for loading a large amount of freight.

In addition, the loading container 10 includes a door 13 for opening or closing a rear part of the container 10.

Further, the loading container 10 may have a plurality of wheels 14 installed thereunder to be readily moved by a vehicle.

The loading container 10 includes palette guides 12 installed at both sides thereof and guiding both sides of the loading palette 40 to prevent horizontal movement of the loading palette 40 conveyed by the conveyor 20.

The conveyor 20 facilitates conveyance of freight into/from the loading container 10, which may be installed at the bottom of each loading section 11 of the loading container 10 in a longitudinal direction thereof.

In addition, the conveyor 20 includes drive shafts (not shown) installed at the front and rear parts thereof to rotate the conveyors 20 through endless tracks.

Further, the loading container 10 includes the drive motors 30 installed therein to rotate the drive shafts, thereby operating the conveyors 20.

The conveyor 20 may include a plurality of stoppers 21 for hooking the loading palettes 40 such that the loading palettes 40 conveyed over the conveyor 20 can be discharged by a certain number.

In addition, the loading container 10 may include a conveyor tension adjustor (not shown) for adjusting tension of the conveyor 20.

The loading palette 40 is formed of a plurality of plate members for loading freight on the conveyor 20 to convey or discharge the freight to the interior or the exterior of the loading container 10.

As shown in FIG. 4, fixing grooves 41 are formed at both sides of the loading palette 40, and a plurality of freight fixing posts 42 are installed at an upper surface of the loading palette 40 to clamp the freight loaded thereon.

The palette up/down cylinders 50 are installed at one side of each of the loading sections 11 of the loading container 10, respectively.

The palette up/down cylinder 50 is connected to the palette lifting member 60 at its one end to transmit an axial force to the palette lifting member 60.

The palette lifting members 60 lift the loading palette 40 over the conveyor 20 to cause the loading palette 40 not to be conveyed when the first loading palette 40 is completely introduced into the loading container 10 by the conveyor 20.

That is, the palette lifting members 60 lift the loading palette 40 over the conveyor 20 using the palette up/down cylinders 50 so that the loading palette 40 cannot be conveyed.

The palette lifting members 60 may be longitudinally installed at both side ends and a center part of the bottom of each loading section 11 of the loading container 10 such that the loading palette 40 can be stably lifted regardless of its weight in a state that the palette lifting members 60 are connected to the palette up/down cylinders 50, respectively.

As shown in FIG. 5, the palette lifting member 60 includes operation grooves 67 having slopes at their upper surfaces, an up/down cam 61 connected to a shaft of the palette up/down cylinder 50 at its one end and reciprocally installed at the bottom of each loading section 11, and an up/down bar 62 positioned just over the up/down cam 61 and having driven rollers 63 installed at its lower surface and guided by the operation grooves 67 of the up/down cam 61.

In addition, the palette lifting member 60 includes a plurality of vertical guide plates 64 installed at the bottom of each loading section 11 and supporting to position the up/down bar 62 and the up/down cam 61 on the same vertical line, and a plurality of vertical guide rollers 65 in contact with the vertical guide plates 64, installed at one side of the up/down bar 62, and vertically guiding the up/down bar 62 depending on reciprocal movement of the up/down cam 61.

Further, the palette lifting member 60 includes an emergency lowering unit 66 (see FIG. 1) for discharging pressure from the palette up/down cylinder 50 to lower the up/down bar when the palette up/down cylinder 50 is abnormal in a state that the up/down bar 62 is lifted up.

The palette fixing part 70 functions to securely fix the loading palette 40 when the loading palette 40 is lifted over the conveyor 20 by the palette lifting member 60.

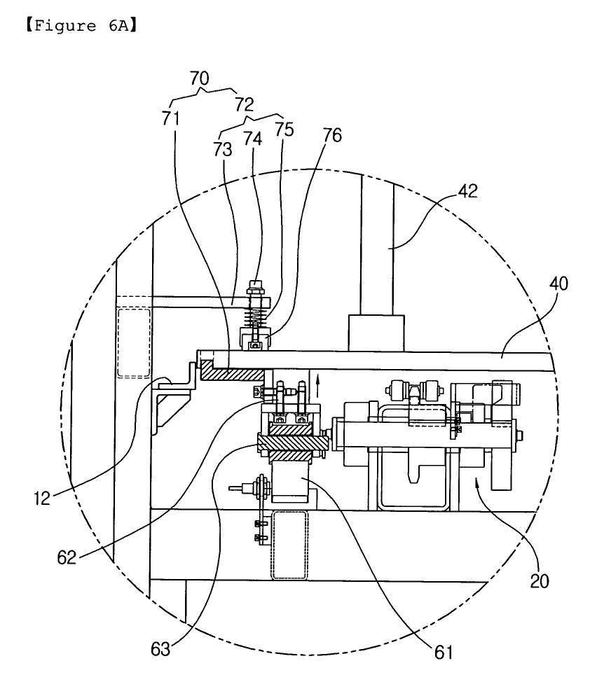

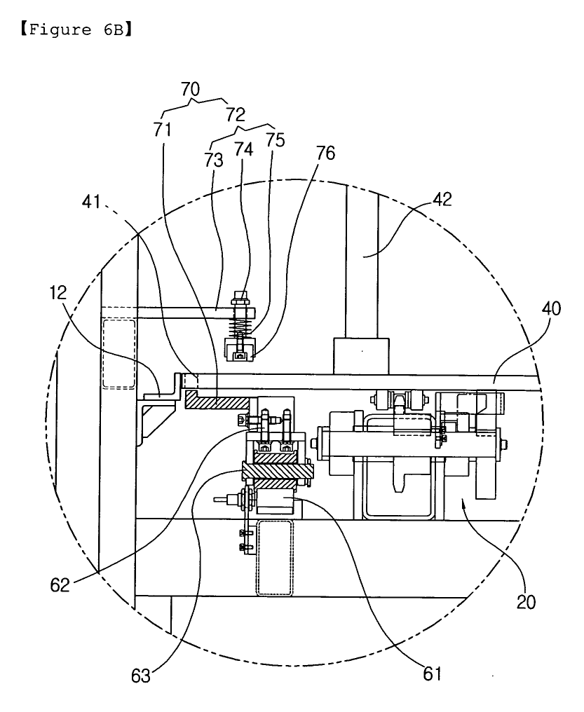

As shown in FIG. 6A, the palette fixing part 70 includes a plurality of palette side fixing plates 71 installed at one side of each up/down bar 62 of the palette lifting member 60 at predetermined intervals, and having end parts inserted into the fixing grooves 41 of the loading palette 40 when the up/down bar 62 is lifted up to stop horizontal movement of the loading palette 40.

The end parts of the palette side fixing plate 71 may have an “L” shape to be readily inserted into the fixing grooves 41 of the loading palette 40 when the up/down bar 62 is lifted up.

In addition, the palette fixing part 70 includes a plurality of palette clamps 72 installed at both sides of each loading section 11 of the loading container 10 at predetermined intervals, and disposed over the loading palette 40.

The palette clamp 72 includes a plurality of connection frames 73 formed at both sides of each loading section 11 of the loading container 10 at predetermined intervals, and a plurality of pressing frames 74 installed at lower end parts of the connection frames 73.

In addition, the pressing frame 74 of the palette clamp 72 includes a resilient member 75 for resiliently pressing the loading palette 40 when the loading palette 40 is lifted up by the up/down bar 62 to be in contact with the upper surface of the pressing frame 74, and absorbing shock generated on the contact.

The resilient member 75 may be a spring, but not limited thereto, and selected from various resilient materials.

In addition, the pressing frame 74 of the palette clamp 72 may have a contact pad 76 installed at its lower end part and formed of a flexible rubber material or synthetic resin to reduce friction caused by contact with the loading palette 40 and partially absorb shock due to the contact.

Therefore, when the up/down bar 62 of the palette lifting member 60 is lifted to lift the loading palette 40, the palette side fixing plates 71 of the palette fixing parts 70 are inserted into the fixing grooves 41 formed at the loading palette 40 to stop reciprocal movement of the loading palette 40.

Further, the pressing frames 74 of the palette clamps 72 resiliently press both upper surfaces of the loading palette 40 using the resilient members 75 to restrict vertical movement of the loading palette 40 and absorb shock due to transportation by a vehicle, thereby preventing damage of the freight.

The freight fixing cylinders 80 function to press and fix the freight loaded on the loading palettes 40 lifted by the palette lifting members 60 and fixed by the palette fixing parts 70.

The freight fixing cylinders 80 may be longitudinally installed at each loading section 11 of the loading container 10 at predetermined intervals.

Finally, a pressure supply apparatus 90 may be installed at one side of the loading container 10 to generate hydraulic or pneumatic pressure to operate the palette up/down cylinders 50 and the freight fixing cylinders 80.

Hereinafter, operation of a freight loading system of a trailer in accordance with an exemplary embodiment of the present invention will be described in detail with reference to FIGS. 1 through 6B.

First, after an operator opens the door 13, power is supplied to the drive motor 30 to rotate the drive shaft, thereby operating the conveyor 20 installed at each loading section 11 of the loading container 10.

At this time, the loading palette 40, on which freight is loaded, is conveyed onto the conveyor 20 installed in the loading container 10 by a conveyor line in a factory (not shown) one by one.

Then, the loading palette 40 is conveyed to a front part of the loading container 10 by the conveyor 20 in the loading container 10.

At this time, the palette lifting member 60 maintains a state that the driven rollers 63 are fixed to position “a” shown in FIG. 5.

Therefore, as shown in FIG. 6B, the loading palette 40 is conveyed to the front part of the loading container 10 by the conveyor 20 without any interference, since the palette side fixing plates 71 and the palette clamps 72 of the palette fixing parts 70 are not in contact with the loading palette 40.

When the first introduced loading palette 40 is conveyed to the foremost part of the loading container 10, a power supply to the drive motor 30 is cut off to stop driving the conveyor 20.

As a result, the loading palettes 40, on which freight is loaded, are arranged in line on the conveyor 20 in each loading section 11 of the loading container 10.

When each loading section 11 of the loading container 10 is filled with the loading palettes 40 arranged in line, the pressure supply apparatus 90 operates to supply pressure to the palette up/down cylinders 50.

When the pressure is supplied to the palette up/down cylinders 50, the palette lifting members 60 operate to lift the loading palettes 40 over the conveyor 20.

Specifically, when the pressure is supplied to the palette up/down cylinders 50, the shafts of the palette up/down cylinders 50 are pulled toward the front part of the loading container 10 to pull the up/down cams 61 connected to end parts of the shafts of the palette up/down cylinders 50.

Then, the driven rollers 62 positioned in the operation grooves 67 of the up/down cams 61 are moved from position “a” to position “b” of FIG. 5, and the vertical guide rollers 65 are moved up in rolling contact with the vertical guide plates 64, thereby lifting up the up/down bars 62 without horizontal movement.

Therefore, the lift of the up/down bars 62 raises the loading palettes 40 over the conveyor 20 to maintain the loading palettes 40 fixedly positioned over the conveyor 20, though the conveyor 20 operates.

In addition, when the loading palettes 40 are lifted over the conveyor 20 by the up/down bars 62, as shown in FIG. 6A, the palette side fixing plates 71 attached to the up/down bars 62 are inserted into the fixing grooves 41 of the loading palettes 40 to restrict horizontal movement of the loading palettes 40.

Further, the palette clamps 72 installed at both sides of the loading container 10 are in resilient contact with the upper surface of the lifted loading palettes 40 to restrict vertical movement of the loading palettes 40.

Next, after pressing the freight loaded on the loading palettes 40 using the freight fixing cylinders 80, an operator closes the door 13 to complete the loading operation.

As described above, when the loading palettes 40 are lifted over the conveyor 20 by the palette lifting members 60 installed at each loading section 11 of the loading container 10, the palette side fixing plates 71 and the palette clamps 72 of the palette fixing parts 70 securely fix the loading palettes 40, and the freight fixing cylinders 80 press and fix the freight loaded on the loading palettes 40, thereby enabling stable transportation of the freight.

As can be seen from the foregoing, it is possible to readily load and unload freight into/from each loading section of a loading container using a conveyor. In addition, when the freight is completely loaded in the loading container and loading palettes are lifted over the conveyor by palette lifting members, palette side fixing plates and palette clamps securely fix the loading palettes and freight fixing cylinders press and fix the freight, thereby enabling stable transportation of the freight.

As described above, although the present invention has been described and illustrated with reference to preferred embodiments and drawings, it should be understood that various modifications and variations of the present invention can be made thereto by those skilled in the art without departing from the spirit and the technical scope of the present invention as defined by the appended claims.

1. A freight loading system of a trailer comprising:
a loading container having a loading section, a door installed at the rear thereof, and a plurality of wheels installed thereunder;
a conveyor installed in a longitudinal direction of the loading section;
a drive motor for driving the conveyor;
a plurality of loading palettes conveyed into the loading container by the conveyor in a state that freight is loaded;
a plurality of palette up/down cylinders installed at the bottom of the loading section;
a plurality of palette lifting members connected to the palette up/down cylinders, installed in a longitudinal direction at the bottom of the loading section, and lifting the loading palettes over the conveyor using the palette up/down cylinders such that the loading palettes are not conveyed when the first conveyed loading palette is completely introduced into the foremost of the loading conveyor by the conveyor;
a plurality of palette fixing parts installed at the loading container and the palette lifting members, and fixing the loading palettes lifted upward by the palette lifting members;
a plurality of freight fixing cylinders longitudinally installed at an upper surface of the loading section at predetermined intervals, and pressing and fixing the freight loaded on the loading palettes when the lifted loading palettes are fixed by the palette lifting members and the palette fixing parts; and
a pressure supply apparatus installed at the loading container and supplying hydraulic or pneumatic pressure to operate the palette up/down cylinders and the freight fixing cylinders.

2. The freight loading system of a trailer according to claim 1, wherein the loading container comprises palette guides installed at both sides thereof to horizontally guide the loading palettes when the loading palettes are conveyed by the conveyor.

3. The freight loading system of a trailer according to claim 1, wherein the conveyor comprises a plurality of stoppers for hooking the loading palettes to discharge or convey a predetermined number of loading palettes.

4. The freight loading system of a trailer according to claim 1, further comprising a plurality of freight fixing frames installed over the loading palettes and clamping the freight loaded on the loading palettes.

5. The freight loading system of a trailer according to claim 1, wherein the palette lifting member comprises:
an up/down cam having an operation groove with a slope at its upper surface, installed at the bottom of each loading section, and having one end connected to the palette up/down cylinder to be reciprocally moved;
an up/down bar installed over the up/down cam, and having a driven roller rolling in the groove of the up/down cam at its lower surface;
a plurality of vertical guide plates installed at the bottom of each of the loading sections, and supporting to position the up/down bar and the up/down cam on the same line; and
a plurality of vertical guide rollers in contact with the vertical guide plates, fixedly installed at one side of the up/down bar, and vertically moving the up/down bar depending on reciprocal movement of the up/down cam.

6. The freight loading system of a trailer according to claim 1, wherein the palette lifting member further comprises an emergency lowering unit for discharging pressure from the palette up/down cylinder to lower the up/down bar when the palette up/down cylinder is abnormal in a state that the up/down bar is lifted.

7. The freight loading system of a trailer according to claim 1, wherein the loading palette has fixing grooves formed at both sides thereof, and the palette fixing part comprises: a plurality of palette side fixing plates installed at one side of each of the up/down bars of the palette lifting member at predetermined intervals, and inserted into the fixing grooves of the loading palette to restrict horizontal movement of the loading palette when the up/down bars of the palette lifting members are lifted; and a plurality of palette clamps installed at both sides of the loading container at predetermined intervals, and positioned over the loading palette.

8. The freight loading system of a trailer according to claim 7, wherein the palette side fixing plate has an “L” shape to be readily inserted into the fixing groove of the loading palette when the up/down bars of the palette lifting members are lifted.

9. The freight loading system of a trailer according to claim 7, wherein the palette clamp comprises:
a plurality of connection frames installed at both sides of the loading section at predetermined intervals;
a plurality of pressing frames vertically coupled with each end of the connection frames;
a plurality of resilient members installed at the pressing frames, resiliently pressing the loading palette when the pressing frames are in contact with an upper surface of the loading palette by lifting the up/down bars of the palette lifting members, and absorbing shock caused by the contact.

10. The freight loading system of a trailer according to claim 9, wherein the pressing frame comprises a contact pad installed at its lower end, formed of a flexible rubber material or synthetic resin, and partially absorbing friction or shock by the contact with the loading palette.

11. The freight loading system of a trailer according to claim 5, wherein the palette lifting member further comprises an emergency lowering unit for discharging pressure from the palette up/down cylinder to lower the up/down bar when the palette up/down cylinder is abnormal in a state that the up/down bar is lifted.
